(19) United States
(12) Patent Application Publication
(10) Pub. No.: US 2016/0181832 A1
(43) Pub. Date: Jun. 23, 2016

(54) SYSTEM AND METHOD FOR CHARGING A SECONDARY BATTERY

(71) Applicant: KABUSHIKI KAISHA TOYOTA JIDOSHOKKI, Aichi (JP)

(72) Inventors: Junichi HATANO, Kariya-shi, Aichi (JP); Kenji NISHIGAKI, Kariya-shi, Aichi (JP)

(73) Assignee: KABUSHIKI KAISHA TOYOTA JIDOSHOKKI, Kariya-shi, Aichi (JP)

(21) Appl. No.: 14/905,003

(22) PCT Filed: Jun. 25, 2014
(86) PCT No.: PCT/JP2014/066842

§ 371 Date: Jan. 14, 2016

(30) Foreign Application Priority Data
Jul. 19, 2013 (JP) 2013-150195

(51) Int. Cl. H02J 7/00; H01M 10/44

(52) U.S. Cl. CPC H02J 7/007; H01M 10/44; H02J 7/0052

(57) ABSTRACT

A charging system supplies a charging current of a constant value (Icc) to a secondary battery, performs a constant-current charging using the charging current until the CCV of the secondary battery reaches a predetermined threshold voltage (Vcc), and repeats a predetermined number of times (N times): —reducing the charging current currently being supplied by a predetermined current reduction amount (ΔIc), —setting the reduced charging current as a new charging current, and —performing the constant-current charging using the new charging current until the CCV of the secondary battery increases by a predetermined voltage increase amount (ΔVx), and then stops the supply of the charging current. The current reduction amount (ΔIc) is set so that the CCV of the secondary battery is larger than the fully-charged voltage (Vfull) of the secondary battery when the charging current currently being supplied is reduced by (ΔIc).

### TECHNICAL FIELD

The present invention relates to a system and a method for charging a secondary battery.

### BACKGROUND ART

In a typical secondary battery charging method, a constant-current charging (CC charging) is first performed to increase the closed-circuit voltage (CCV) of the secondary battery to a predetermined voltage, and then a constant-voltage charging (CV charging) is performed to put the secondary battery into a fully-charged state. However, when the secondary battery is charged in the constant-voltage charging mode, it is necessary to continuously reduce the charging current as the state of the secondary battery approaches the fully-charged state, whereby the charging amount per unit of time is reduced. As a result, the charging time is increased.

In order to solve the above-described problem, Patent Literature 1 discloses a method which supplies a constant charging current to a secondary battery to perform a constant-current charging, and then repeats: reducing the charging current by a predetermined current amount when the CCV of the secondary battery reaches a predetermined switching voltage, —setting the reduced charging current as a new charging current, and —performing the constant-current charging using the new charging current, whereby the secondary battery is put into the fully-charged state (see FIG. 6 of Patent Literature 1). In this method, although the charging current is gradually reduced as the state of the secondary battery approaches the fully-charged state, since the current is not reduced in each constant-current charging time, it is possible to increase the charging amount per unit of time as compared to the above-described method and to shorten the charging time to a certain extent.

### CITATION LIST

### Patent Literature

PTL 1 Japanese Patent Application Publication No. H08-203563

### SUMMARY OF INVENTION

### Technical Problem

However, in the method disclosed in Patent Literature 1, when switching the charging current, the charging current is drastically reduced so that the CCV of the secondary battery is smaller than the voltage in the fully-charged state (V3 in FIG. 6), the charging amount per unit of time is reduced and the charging time cannot be shortened sufficiently. The present invention is made to solve such a problem, and an object thereof is to provide a system and a method for charging a secondary battery, capable of sufficiently shortening the charging time.

### Solution to Problem

In order to solve the above-described problem, the present invention concerns a secondary battery charging system for charging a secondary battery. The system supplies a charging current of a constant value to the secondary battery using a current supply unit, performs a constant-current charging using the charging current until a closed-circuit voltage of the secondary battery reaches a predetermined threshold voltage, and repeats a predetermined number of times: —reducing the charging current currently being supplied from the current supply unit by a predetermined current reduction amount, —setting the reduced charging current as a new charging current, and —performing the constant-current charging using the new charging current until the closed-circuit voltage of the secondary battery increases by a predetermined voltage increase amount. Each predetermined current reduction amount in the predetermined number of times of repetition is set so that the closed-circuit voltage of the secondary battery is larger than the fully-charged voltage of the secondary battery when the charging current currently being supplied from the current supply unit is reduced by the predetermined current reduction amount.

The present invention also concerns a secondary battery charging method for charging a secondary battery. The method supplies a charging current of a constant value to the secondary battery, performs a constant-current charging using the charging current until a closed-circuit voltage of the secondary battery reaches a predetermined threshold voltage, and repeats a predetermined number of times: —reducing the charging current currently being supplied to the secondary battery by a predetermined current reduction amount, —setting the reduced charging current as a new charging current, and —performing the constant-current charging using the new charging current until the closed-circuit voltage of the secondary battery increases by the predetermined voltage increase amount. Each predetermined current reduction amount in the predetermined number of times of repetition is set so that the closed-circuit voltage of the secondary battery is larger than the fully-charged voltage of the secondary battery when the charging current currently being supplied to the secondary battery is reduced by the predetermined current reduction amount.

### Advantageous Effects of Invention

According to the system and method for charging a secondary battery of the present invention, it is possible to sufficiently shorten the charging time of a secondary battery.

### BRIEF DESCRIPTION OF DRAWINGS

FIG. 1 is a diagram illustrating a configuration of a secondary battery charging system according to an embodiment of the present invention.

FIG. 2 is a flowchart illustrating a charging process executed by the secondary battery charging system according to an embodiment of the present invention.

FIG. 3(a) is a diagram illustrating a time variation of the CCV and OCV of the secondary battery, and FIG. 3(b) is a diagram illustrating a time variation of the charging current supplied to the secondary battery.

FIG. 4 is a diagram illustrating a case in which a polarization effect of the battery is taken into account and a case in which the polarization effect is not taken into account, in the secondary battery charging system according to an embodiment of the present invention.

### DESCRIPTION OF EMBODIMENTS

Hereinafter, an embodiment of the present invention will be described based on the accompanying drawings.

### Embodiment

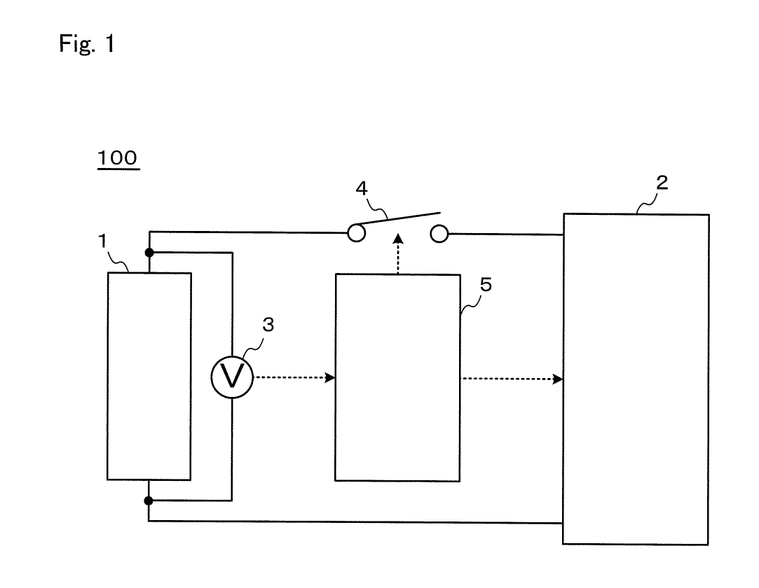

FIG. 1 illustrates a configuration of a secondary battery charging system 100 according to an embodiment of the present invention. The charging system 100 comprises a secondary battery 1, a current control power supply 2 which supplies a charging current to the secondary battery 1, a voltage sensor 3 which measures the voltage of the secondary battery 1, a switch 4 provided between the secondary battery 1 and the power supply 2, and a control unit 5.

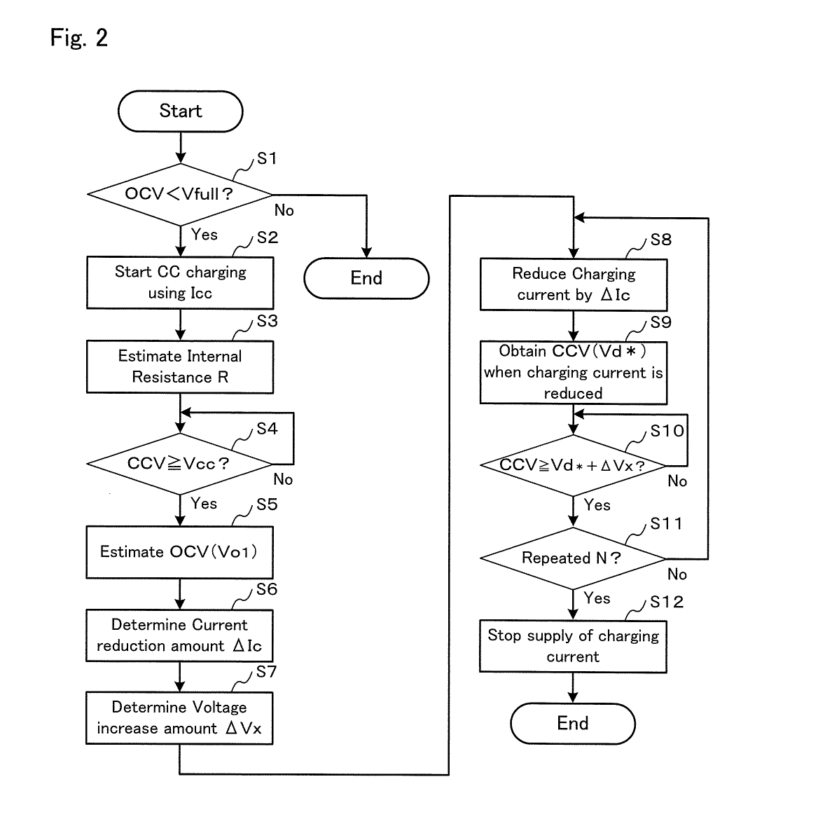

The control unit 5 is constructed of a microcomputer and is configured to obtain the voltage of the secondary battery 1 measured by the voltage sensor 3 and to control an output current of the power supply 2 and an open/closed state of the switch 4 so as to control a charging process of the secondary battery 1 illustrated in the flowchart of FIG. 2. Hereinafter, the details of each step of the charging process illustrated in the flowchart of FIG. 2 will be described sequentially. At the initial state of the charging process, the power supply 2 does not output a current and the switch 4 is in an open state.

First, in step S1, the control unit 5 obtains the open-circuit voltage (OCV) of the secondary battery 1 measured by the voltage sensor 3 and compares the obtained OCV with a previously measured OCV in the fully-charged state (fully charged voltage (Vfull)) of the secondary battery 1. If the OCV of the secondary battery 1 is smaller than the fully-charged voltage (Vfull), steps S2 to S12 are executed. On the other hand, if the OCV of the secondary battery 1 is equal to or larger than (Vfull), which means the secondary battery is already in the fully-charged state, the charging process ends.

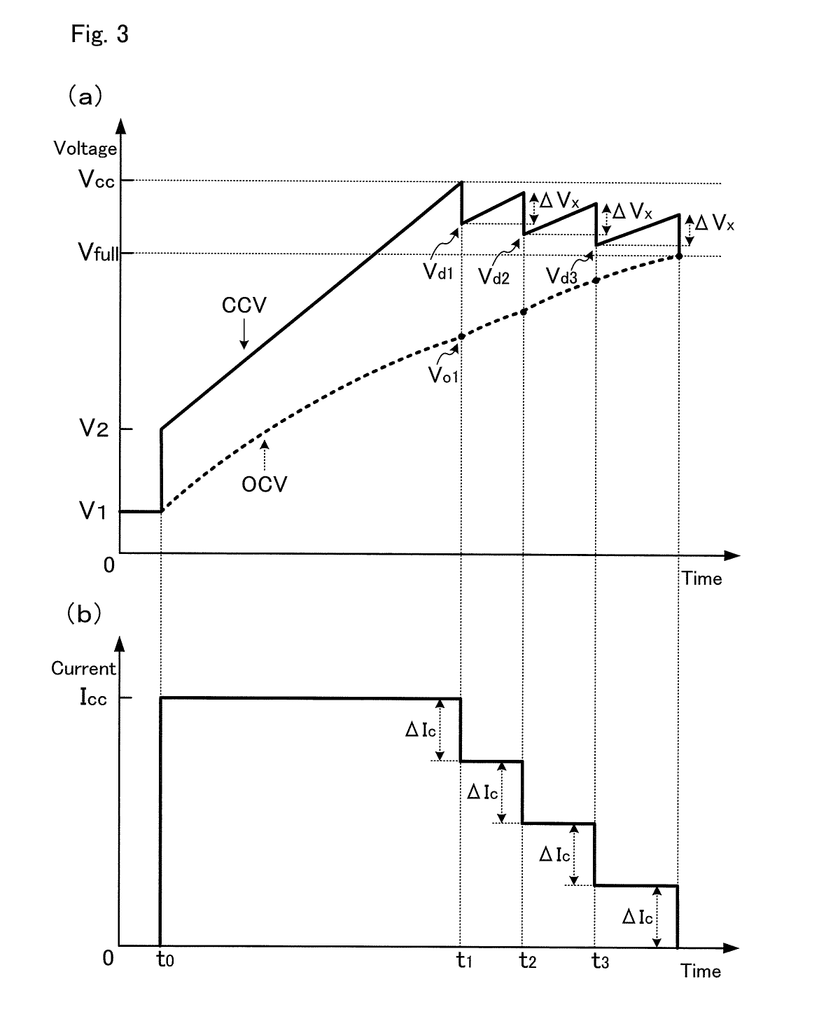

In step S2, at time t0, the control unit 5 puts the switch 4 into a closed state and enables the power supply 2 to output a charging current of a constant value (Icc) so as to start the constant-current charging (CC charging) of the secondary battery 1 using the charging current (see FIG. 3(b)). As a result, the charging amount of the secondary battery 1 increases with time, and the CCV of the secondary battery 1 measured by the voltage sensor 3 also increases with time (see FIG. 3(a)) because there is a correlation between the charging amount and the closed-circuit voltage (CCV).

In step S3, the control unit 5 estimates the internal resistance (R) of the secondary battery 1. Specifically, the internal resistance (R) is estimated from the voltages of the secondary battery 1 measured by the voltage sensor 3 immediately before/after the charging current is supplied in step S2, according to the following equation:

R=(V2−V1)/Icc.

In the above-described equation, (V1) is the OCV immediately before the current is supplied, and (V2) is the CCV immediately after the current is supplied.

In step S4, the control unit 5 waits until the CCV of the secondary battery 1 reaches a predetermined threshold voltage (Vcc), while continuously supplying the charging current from the power supply 2 to the secondary battery 1. The threshold voltage (Vcc) is set so that (Vcc) is larger than the fully-charged voltage (Vfull) and the OCV in a state in which the CCV of the secondary battery 1 is (Vcc) (Vo1 in FIG. 3(a)) is smaller than the fully-charged voltage (Vfull).

When it is determined in step S4 that the CCV of the secondary battery 1 has reached the threshold voltage (Vcc), in step S5 the control unit 5 estimates the OCV of the secondary battery 1 in that state (Vo1 in FIG. 3(a)) according to the following equation:

Vo1=(Vcc=R×Icc).

In the above-described equation, the polarization effect of the secondary battery 1 is not taken into account. In general, a more accurate OCV can be estimated when the polarization effect of the battery is taken into account, and in such case the estimated OCV is smaller than the value obtained by the above-described equation. However, in the present invention, the polarization effect is not taken into account so that the estimated OCV is larger than the actual value. The reasons therefor will be described later.

In step S6, the control unit 5 determines a predetermined current reduction amount (ΔIc), which will be used in step S8, according to the following equation:

ΔIc=Icc/(N+1).

In the above-described equation, (N) is a positive integer and FIG. 3(b) illustrates an example of N=3. In the present invention, in order to increase the charging amount per unit of time as much as possible, the value (N) is set so that the CCV of the secondary battery 1 when the charging current is reduced by (ΔIc) in step S8 (Vd1, Vd2, and Vd3 in FIG. 3(a)) is larger than the fully-charged voltage (Vfull). Specifically, the following relation needs to be satisfied so that the CCV is larger than the fully-charged voltage (Vfull) when the charging current is reduced by (ΔIc),

R×ΔIc<Vcc−Vfull.

Moreover, since ΔIc=Icc/(N+1),

The value (N) is set to satisfy the following relation:

N>(R×Icc)/(Vcc−Vfull)−1.

In step S7, the control unit 5 determines a predetermined voltage increase amount (ΔVx), which will be used in step S10, according to the following equation:

$$\begin{matrix}Δ Vx = ( Vfull - Vol ) / N \\ = ( Vfull - ( Vcc - R \times Icc ) ) / N .\end{matrix}$$

In the above-described equation, (ΔVx) is defined as a voltage obtained by dividing the gap between the fully-charged voltage (Vfull) and the estimated OCV (Vo1) in FIG. 3(a) by (N).

Subsequently, in step S8, the control unit 5 reduces the charging current currently being supplied from the power supply 2 by the current reduction amount (ΔIc) determined in step S6, sets the reduced charging current as a new charging current, and performs the constant-current charging of the secondary battery 1 using the new charging current (time t1 in FIG. 3(b)).

In step S9, the control unit 5 obtains the CCV of the secondary battery 1 measured by the voltage sensor 3 (Vd1 in FIG. 3(a)) when the charging current is reduced by (ΔIc) in step S8.

In step S10, the control unit 5 waits until the CCV of the secondary battery 1 reaches Vd1+ΔVx while continuously supplying the charging current from the power supply 2 to the secondary battery 1, i.e. the control unit 5 waits until the CCV of the secondary battery 1 increases by the voltage increase amount (ΔVx) determined in step S7.

When it is determined in step S10 that the CCV of the secondary battery 1 has increased by the voltage increase amount (ΔVx), in step S11 the control unit 5 checks whether steps S8 to S10 have been repeated (N) times. If the number of repetitions of steps S8 to S10 is smaller than (N), the flow returns to step S8. On the other hand, if the steps have been repeated (N) times, the flow proceeds to step S12. In step S12, the switch 4 is opened, the supply of the charging current from the power supply 2 to the secondary battery 1 is stopped and the process of charging the secondary battery 1 ends.

While steps S8 to S10 are repeated (N) times (three times in the example of this embodiment), the OCV of the secondary battery 1 approaches the fully-charged voltage (Vfull) and the secondary battery 1 is charged (see dotted line in FIG. 3(a)). During this period of time, the charging current supplied from the power supply 2 to the secondary battery 1 gradually reduces by (ΔIc) (FIG. 3(b)), and the CCV of the secondary battery 1 gradually reduces while repeatedly increasing by (ΔVx) after temporarily reducing during the reduction in the charging current (see solid line in FIG. 3(a)). Since the CCV of the secondary battery 1 will not be smaller than the fully-charged voltage (Vfull) as described above, it is possible to increase the charging amount per unit of time as compared to the method of Patent Literature 1 in which the charging current is reduced so that the CCV is smaller than the fully-charged voltage when switching the charging current. Thus, the charging time is sufficiently shortened.

As described above, the secondary battery charging system 100 according to this embodiment supplies a charging current of a constant value (Icc) to the secondary battery 1, performs a constant-current charging using the charging current until the CCV of the secondary battery 1 reaches a predetermined threshold voltage (Vcc), and repeats a predetermined number of times (N times): —reducing the charging current currently being supplied by a predetermined current reduction amount (ΔIc), —setting the reduced charging current as a new charging current, and —performing the constant-current charging using the new charging current until the CCV of the secondary battery 1 increases by a predetermined voltage increase amount (ΔVx), and then stops the supply of the charging current. The current reduction amount (ΔIc) is set so that the CCV of the secondary battery 1 is larger than the fully-charged voltage (Vfull) of the secondary battery 1 when the charging current currently being supplied is reduced by (ΔIc). In this way, it is possible to increase the charging amount per unit of time as compared to the method of Patent Literature 1 and to sufficiently shorten the charging time.

The following are the reasons why the polarization effect of battery is not taken into account when estimating the OCV of the secondary battery 1 in step S5 of FIG. 2.

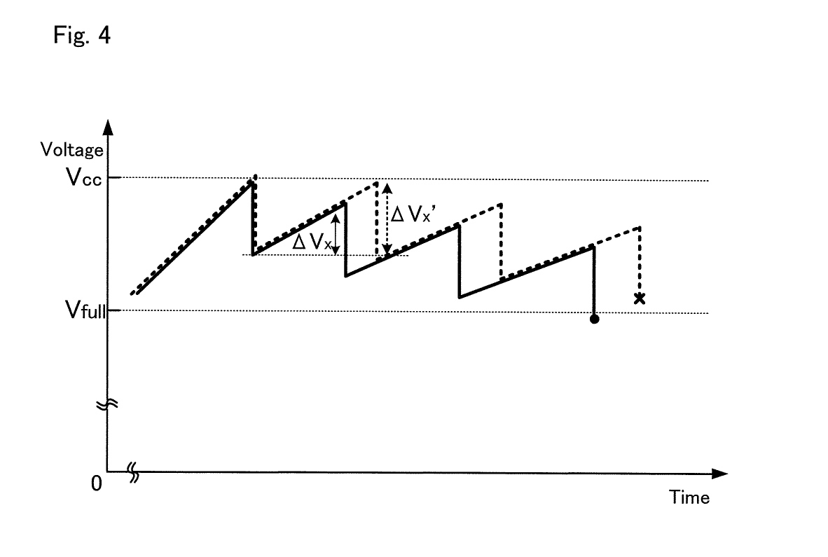

In the above-described embodiment, in step S7 of FIG. 2, the voltage increase amount (ΔVx) is defined as a voltage obtained by dividing the gap between the fully-charged voltage (Vfull) in FIG. 3(a) and the estimated OCV (Vo1) by (N). If the gap between (Vfull) and (Vo1) is strictly divided by (N) without any margin, the OCV of the secondary battery 1 at the end of the charging may exceed the fully-charged voltage (Vfull) as indicated by the dotted line (the voltage increase amount (ΔV×′)) in FIG. 4. Thus, by ignoring the polarization effect when estimating the OCV in step S5, the value (Vo1) is intentionally estimated to be larger than the actual value so that the voltage increase amount (ΔVx) is slightly smaller than the value obtained by strictly dividing the gap between (Vfull) and (Vo1) by (N). In this way, as indicated by the solid line (the voltage increase amount (ΔVx)) in FIG. 4, the OCV of the secondary battery 1 at the end of the charging can be made reliably smaller than the fully-charged voltage (Vfull).

### Other Embodiments

In the above-described embodiment, in (N) times repetition of steps S8 to S10 of FIG. 2, each current reduction amount (ΔIc) and each voltage increase amount (ΔVx) are set to the same value. However, these amounts may be set to different values for each repetition.

1. A secondary battery charging system for charging a secondary battery, wherein the system supplies a charging current of a constant value to the secondary battery using a current supply unit, performs a constant-current charging using the charging current until a closed-circuit voltage of the secondary battery reaches a predetermined threshold voltage, and repeats a predetermined number of times:
reducing the charging current currently being supplied from the current supply unit by a predetermined current reduction amount,
setting the reduced charging current as a new charging current, and
performing the constant-current charging using the new charging current until the closed-circuit voltage of the secondary battery increases by a predetermined voltage increase amount, wherein:
each predetermined current reduction amount in the predetermined number of times of repetition is set so that the closed-circuit voltage of the secondary battery is larger than a fully-charged voltage of the secondary battery when the charging current currently being supplied from the current supply unit is reduced by the predetermined current reduction amount.

2. The secondary battery charging system according to claim 1, wherein:
the predetermined current reduction amounts in the predetermined number of times of repetition are the same,
the current reduction amount is determined according to the following equation:
ΔIc=Icc/(N+1),
where ΔIc is the predetermined current reduction amount, Icc is the constant value of the charging current supplied first to the secondary battery, and N is the predetermined number of times, and
the value N is set to satisfy the following relation:
N>(R×Icc)/(Vcc−Vfull)−1,
where R is an internal resistance of the secondary battery, Vfull is the fully-charged voltage, and Vcc is the predetermined threshold voltage.

3. The secondary battery charging system according to claim 2, wherein:
the predetermined voltage increase amounts in the predetermined number of times of repetition are the same, and
the predetermined voltage increase amount ΔVx is determined according to the following equation:
ΔVx=(Vfull−(Vcc−R×Icc))/N.

4. A secondary battery charging method for charging a secondary battery, wherein the method supplies a charging current of a constant value to the secondary battery, performs a constant-current charging using the charging current until a closed-circuit voltage of the secondary battery reaches a predetermined threshold voltage, and repeats a predetermined number of times:
reducing the charging current currently being supplied to the secondary battery by a predetermined current reduction amount,
setting the reduced charging current as a new charging current, and
performing the constant-current charging using the new charging current until the closed-circuit voltage of the secondary battery increases by a predetermined voltage increase amount, wherein:
each predetermined current reduction amount in the predetermined number of times of repetition is set so that the closed-circuit voltage of the secondary battery is larger than a fully-charged voltage of the secondary battery when the charging current currently being supplied to the secondary battery is reduced by the predetermined current reduction amount.
